(19) United States
(12) Patent Application Publication
(10) Pub. No.: US 2013/0305076 A1
(43) Pub. Date: Nov. 14, 2013

(54) UNATTENDED WAKEUP

(71) Applicant: Lee Warren Atkinson, Houston, TX (US)

(72) Inventor: Lee Warren Atkinson, Houston, TX (US)

(21) Appl. No.: 13/981,082

(22) PCT Filed: Apr. 29, 2011
(86) PCT No.: PCT/US11/34567

§ 371 Date: Jul. 22, 2013

(51) Int. Cl. G06F 1/30

(52) U.S. Cl. CPC G06F 1/305
USPC 713/340

(57) ABSTRACT

Embodiments provide methods and apparatuses delaying unattended wakeup events based on the operating conditions. In one embodiment, the operating conditions may be detected by the computing device while in a first power state, wherein the unattended wakeup event is to transition the computing device to a second power state.

### BACKGROUND

Computing devices such as notebook computers, netbook computers, and tablets, among others, may perform various operations without user interaction. For example, a computing device may periodically wake up from a low power mode, while unattended, and perform an operation. Operations may include accessing, retrieving, and processing data. In this manner, the computing device may prevent a delay associated with a user powering the device and manually performing the operations.

### BRIEF DESCRIPTION OF THE DRAWINGS

FIG. 1 is a block diagram of an apparatus in accordance with an example of the present disclosure;

FIG. 2 is a block diagram, of an apparatus in accordance with an example of the present disclosure;

FIG. 3 is a block diagram of an apparatus in accordance with an example of the present disclosure;

FIG. 4 illustrates an apparatus in accordance with an example of the present disclosure;

FIG. 5 illustrates an apparatus in accordance with an example of the present disclosure; and

FIGS. 6-11 illustrate flow diagrams in accordance with various examples of the present disclosure.

### DETAILED DESCRIPTION

The ability to transition between various power states and perform operations while unattended, described herein as unattended wakeup, is becoming more commonplace in computing devices. As an example, a computing device may periodically wake from a low power state and access a network to retrieve data such as electronic mail (e-mail). The data is then available to a user when the computing device is next accessed.

Unattended wakeup events may provide benefits in the way of efficiency and readiness, but may also lead to problems. For example, while computing devices may withstand a wider range in temperatures and higher amounts of shock while in a sleep state (e.g. a low power mode), these operating conditions may damage various components while in a non-sleep state. Consequently, if a user assumes the computing device is in a low power mode and thereby safe for transportation or storage, an unattended wakeup event may result in damage to the computing device or result in computing errors.

In the present disclosure, a computing device configured to dynamically disable and/or delay an unattended wakeup event based on various environmental and/or operating conditions is disclosed. The disclosure may discuss corresponding methods, articles of manufacture, and systems.

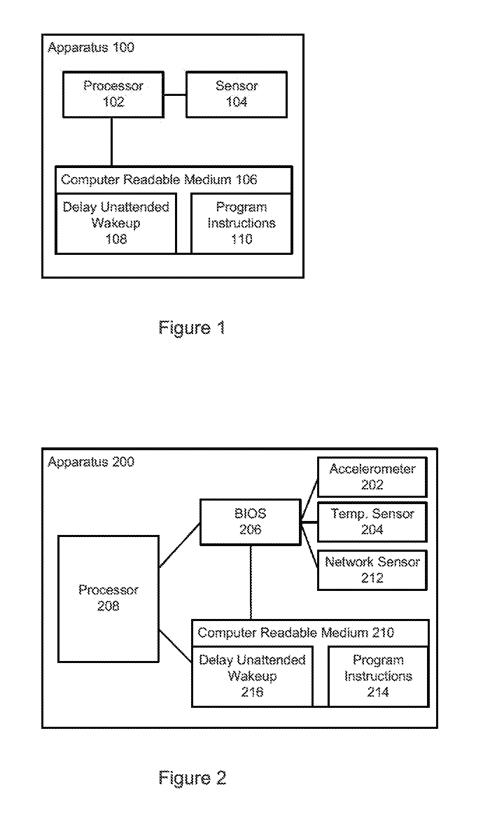

Referring to FIG. 1, an apparatus 100 is illustrated in accordance with various embodiments. The apparatus 100 includes a sensor 104, a processor 102, and a computer readable medium 106 having a plurality of programming instructions 110. The apparatus 100 may be a computing device such as, but not limited to, a notebook computer, a netbook computer a tablet computing device, a smart phone, or a desktop computer. Other computing devices are contemplated.

The sensor 104 may be a sensor configured to detect an operating condition of the apparatus 100. An operating condition is a condition or characteristic corresponding to an environment or situation in which the computing device is to operate. For example, operating conditions include, but are not limited to, whether the computing device is within a network (e.g., network availability), temperatures associated with either internal components of the computing device or temperatures of the computing device's environment, or whether the computing device is experiencing shock or vibration, for instance, through movement. Correspondingly, the sensor 104 may be a network sensor, a temperature sensor, or an accelerometer. Other sensors and combinations of sensors are contemplated.

Processor 102, and other processors described in the present disclosure, may be general purpose processors, an application specific integrated circuits (ASIC), or alternatively, may be components of a chipset configured to perform various functions. The processor 102 may be active in various power states of the apparatus 100. For example, the processor 102 may be operational in states S0-S4 of the Advanced Configuration and Power Interface (ACPI) specification. The processor 102 may be coupled to computer readable medium 106, and consequently, access and execute instructions stored as programming instructions 110. The programming instructions 110 may enable the apparatus 100 detect an operating condition of the apparatus while in a first power state, via the sensor 104. The first power state may be a low power state such as any of states S1-S4.

In response to the detected operating conditions, apparatus 100 may determine whether or not to execute an unattended wakeup event. An unattended wakeup event may be an event, unattended by a user, in which the apparatus 100 transitions from a first power state to a second power state to perform an operation. The first power state is a low power state (e.g., S1-S4) and the second power state is an operative power state (S0). Based on the detected operating conditions, the apparatus 100 via the processor 104 may delay 108 the unattended wakeup event, wherein the unattended wakeup event transitions the apparatus 100 from a first power state to a second power state to perform the operation.

in this manner, the apparatus 100 is prevented from performing an unattended wakeup event in operating conditions that may detrimentally impact the apparatus 100, or any components within the apparatus 100. The unattended wakeup event may be delayed for an amount of time, until the operating condition detected by the sensor 104 has changed, or until a favorable operating condition has been detected. A favorable operating condition is an operating condition that indicates a favorable environment for operation of the computing system.

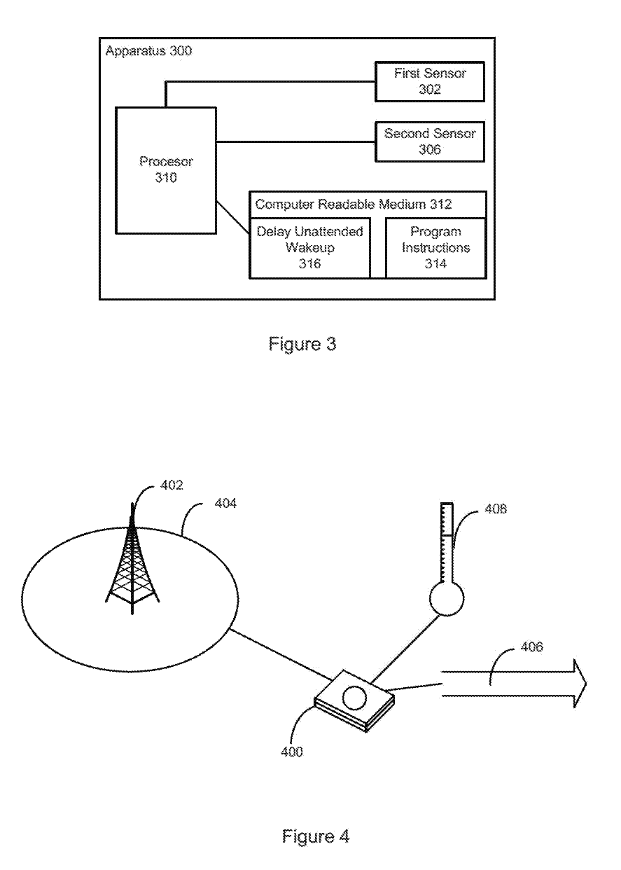

Referring now to FIG. 2, another apparatus is illustrated in accordance with an embodiment. Apparatus 200 includes a plurality of sensors including an accelerometer 202, a temperature sensor 204, and a network sensor 212, the apparatus 200 further includes a basic input/output operating system (BIOS) 206, a processor 208 and a computer readable medium 210 having program instructions 214. Similar to apparatus 100, apparatus 200 may be a computing device such as, but not limited to, a notebook computer, a netbook computer, a tablet computing device, a smart phone, or a desktop computer. Other computing devices are contemplated.

The accelerometer 202 may be a sensor configured to detect an operating condition such as movement and/or vibration. The temperature sensor 208 is a sensor configured to detect an operating condition such as a temperature. The temperature may be the temperature of an environment in which the apparatus 200 is disposed, or alternatively, may be an internal temperature of the apparatus 200. The network sensor 212 may be a sensor configured to detect an operating condition such as whether the apparatus 200 is within a network area. The network sensor 212 may be configured to determine whether a network is available and accessible.

In the illustrated example, the BIOS 206 may be configured to load an operating system and detect various peripherals, among other tasks. The BIOS 206 may be coupled to the plurality of sensors 202, 204, and 212 and be configured to detect various operating conditions. Additionally, the BIOS 206 may load the operating system in response to an unattended \makeup event. For example, in response to a scheduled wakeup event, the BIOS 208 may transition the apparatus 200 from a first power state to a second power state to perform an operation.

In one example, an unattended wakeup event may be scheduled. The unattended wakeup event may be configured to transition the apparatus 200 from a low power state (e.g., S1-S4) to an operational state to perform an operation. The BIOS 206, prior to transitioning the apparatus may detect an operating condition via the plurality of sensors 202, 204, and 212, and in response to the operating condition, the BIOS 206 may delay the unattended wakeup condition.

In one example, the BIOS 206 may monitor accelerometer 202. In response to detecting movement or vibration, the BIOS may delay the unattended wakeup event. Movement or vibration may be indicative that the apparatus 200 is being moved. Attempts to operate apparatus 200 while being moved may result in errors or damage to various components.

In another example the BIOS 208 may monitor temperature sensor 204. In response to detecting a temperature outside of a predetermined to range, the BIOS 206 may delay the unattended wakeup event. High or low temperature, for example, those around boiling and freezing may have an impact on the apparatus's ability to retain data in memory, such as random access memory. Operating the apparatus 200 within certain temperatures ranges may cause errors or result in damage to various components. Various temperature ranges may predetermined for the apparatus 200 based on factors.

In another example, the BIOS 206 may monitor the network sensor 212. In response to failing to detect a network, the BIOS 206 may delay the unattended \makeup event. In an embodiment where the unattended wakeup event is attempting to utilize a network, absence of a network may negate the need for transitioning the apparatus 200 from a low power state to an operative power state.

In various embodiments, the BIOS 206 may delay the unattended wakeup event in a manner of ways. For example, the BIOS 206 may delay the unattended wakeup event for a predetermined amount of time, for example one hour. Other amounts of time are contemplated. In another example, the BIOS 206 may delay the unattended wakeup event while the BIOS 206 monitors the operating condition. Upon the operating condition that caused the delay ceasing, the unattended wakeup event may be executed. In another example, the BIOS 206 may delay the unattended wakeup event until a favorable operating condition is detected. In various embodiments, a favorable operating condition may be that the apparatus 200 is stable as monitored by the accelerometer, the apparatus is operating within a normal temperature range as determined by the temperature sensor 204, or the apparatus is within an available network as indicated by network sensor 212. Other favorable operating conditions may include, whether the screen is open, in the case of a laptop, or that ambient light is present, thereby indicating that the laptop is situated on a desk or platform.

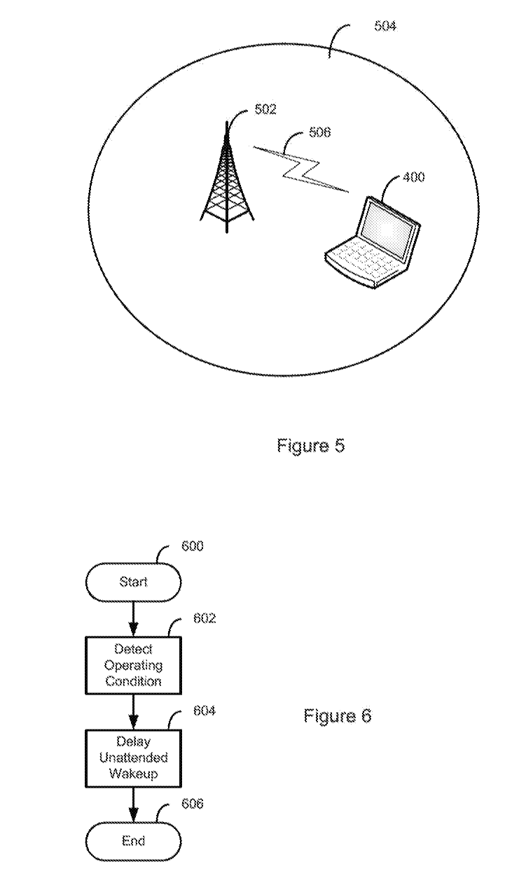

Referring now to FIG. 3, another embodiment is illustrated in accordance with the present disclosure. FIG. 3 illustrates an apparatus 300 including a first sensor 302, a second sensor 306, a processor 310, and a computer readable medium 312 having programming instructions 314. Similar to apparatuses 100 and 200, apparatus 300 may be a computing device such as, but not limited to, a notebook computer, a netbook computer, a tablet computing device, a smart phone, or a desktop computer. Other computing devices are contemplated.

Programming instructions 314 may enable the processor 310 to execute an unattended wakeup event. The unattended wakeup event may be configured to occur based on a predetermined time schedule, for example, a schedule determined by a user, or alternatively based on network availability. As illustrated in FIG. 3, processor 300 may be configured to monitor first sensor 302. First sensor 302 may be a network sensor configured to detect availability of a network. The processor 310 may be configured to generate an unattended wakeup event in response to detection of an available network via a first sensor. The unattended wakeup event may be configured to transition the apparatus from a first power state to a second power state to perform an operation.

In response to detecting an available network, the processor 310 may be further configured to monitor a second sensor 306. The second sensor 306 may be an accelerometer or a temperature sensor, other sensor are contemplated. The second sensor 306 may be configured detect an operating condition corresponding to the type of sensor 306. In response to a detected operating condition, the processor 310 may be configured to delay the unattended wakeup event.

In one embodiment, the delay may be a predetermined amount of time, for example an hour, in another embodiment, the delay may continue for as long as the operating condition persists. For example, the sensor that detected the operating condition may be monitored and upon an indication that the operating condition has ceased, the delay may correspondingly cease. In another example the delay may persist until a favorable operating condition has been detected. In various embodiments, the processor may then transition the apparatus 300 from the first power state to the second power state to perform the operation, wherein the transition is in response to expiration of the delay.

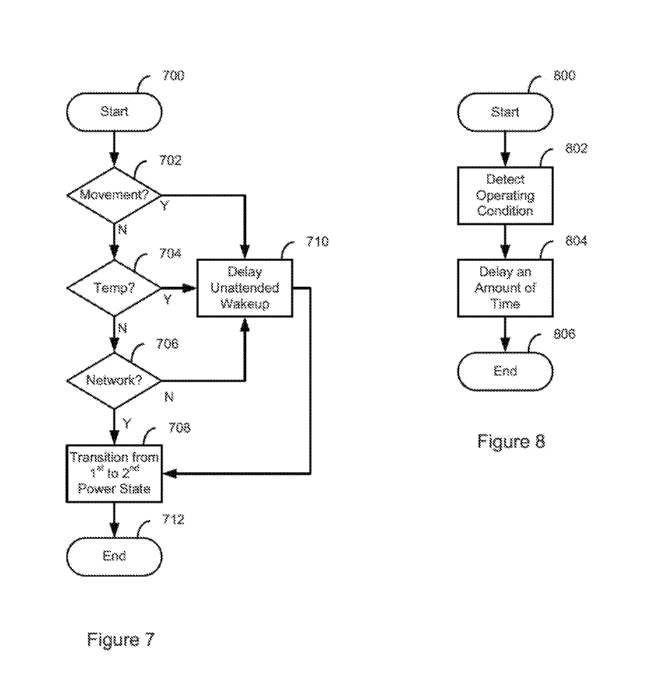

Referring to FIG. 4 an apparatus is illustrated in accordance with an embodiment, FIG. 4 illustrates a computing device 400 configured to detect a plurality of operating conditions. The operating conditions include network availability, temperature, and movement and/or vibration.

The apparatus 400 may utilize a first sensor, for example a network sensor to detect network availability. A network 404 is associated with a network access point 402. The apparatus 400 may detect a network 404 and upon detecting the network, trigger an unattended wakeup event, in one example, the apparatus 400 may determine whether the available network is accessible by the apparatus 400. If the network is present, but not accessible to the apparatus 400, the apparatus 400 may continue to monitor for other networks. In another example, the apparatus 400 may detect the network based on a wake on LANIUSB event. A wake on LANIUSB event is an event when a network is transmitted to a network interface card (NI % and the NIC wakes up the computer. The receipt of a wake on LAN/USB event may indicate the availability of a network.

The apparatus 400 may utilize a second sensor, for example a temperature sensor to monitor a temperature of the apparatus 400, or alternatively, the temperature of the environment. Based on a temperature being too high or too low, the apparatus 400 may delay an unattended wakeup event. Examples of temperatures that are too high include temperatures over one hundred degrees Fahrenheit. Examples of temperature that are too low include temperatures below thirty two degrees Fahrenheit. Temperatures considered too high or too low may vary depending upon the apparatus 400, consequently, other temperatures are contemplated.

The apparatus 400 may utilize a third sensor, for example an accelerometer to monitor for movement 406 and/or vibration. When an accelerometer detects movement 406, the unattended wakeup event may be delayed. Movement may cause various components to operate incorrectly.

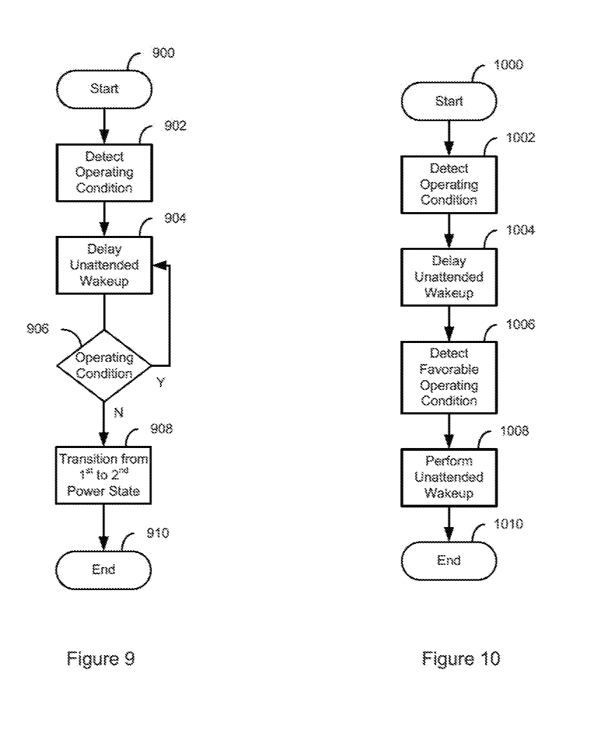

Referring to FIG. 5, the apparatus 400 is illustrated in accordance with another embodiment. The apparatus 400 may be configured to detect favorable operating conditions, and in response, transition from the first power state to the second power state to perform an operation.

In the illustrated example, the apparatus 400 is illustrated in an open position. The apparatus 400 may detect the open condition via one or more latches or sensors and construe the open position as a favorable operating condition. Additionally, the apparatus 400 may detect a network 504. The network 604 may be a known and accessible network and indicate a favorable operating condition. In response to the favorable operating condition, the apparatus 400 may transition to an operative power state and perform an operation such as a query to an email server 506. Other operations are contemplated.

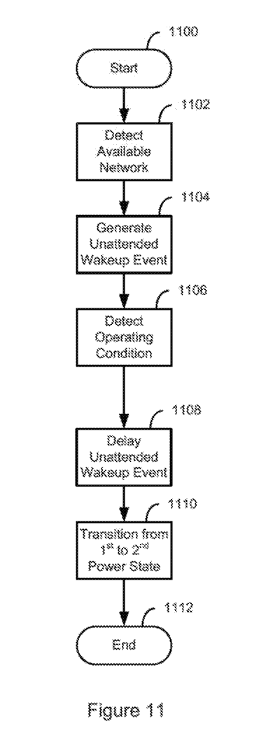

Referring now to FIGS. 6-11, various flow diagrams are illustrated. The flow diagrams illustrate methods and/or programming instructions that may be executed or performed by any of the apparatuses described with reference to FIGS. 1-3.

Referring to FIG. 6, the method may begin at 600 and progress to 602, where a computing device may detect an operating condition while in a first power state. The first power state may be a low power state, for example any of the power states S1-S4. Upon detecting an operating condition at 602, the computing device may delay an unattended wakeup event based on the operating condition at 604. The unattended wakeup event may be configured to transition the computing device from the first power state to a second power state to perform an operation. The method may then end at 606.

Referring to FIG. 7, another flow diagram is illustrated in accordance with an embodiment. The flow diagram begins at 700 and progresses to 702 where the apparatus may monitor movement via a sensor such as an accelerometer. If movement is detected at 702, the apparatus may delay an unattended wakeup event at 710. If movement is not detected at 702, the apparatus may monitor a temperature at 704 via a temperature sensor.

Monitoring temperature may include monitoring a temperature inside a housing of the apparatus, or alternatively, monitoring a temperature outside of the housing of the apparatus. If a temperature above or below a predefined threshold is detected, the apparatus may delay the unattended wakeup at 710. If a temperature above or below predefined thresholds is not detected, the apparatus may monitor for network availability at 706.

Monitoring for network availability may include monitoring for whether a network is accessible by the apparatus. If a network is not available or alternatively, not accessible, the apparatus may delay an unattended wakeup event at 710. If a network is available and accessible at 706, the apparatus may transition from a first power state to a second power state to perform an operation, the transition based on the unattended wakeup event.

Returning to 710, if an unattended wakeup event has been delayed based on an operating condition, the apparatus may, based upon expiration of the delay, expiration of the operating condition, or detection of favorable operating conditions, transition the apparatus from the first power state to the second power state to perform an operation at 708. The flow diagram may then end at 712.

Referring to FIG. 8, another flow diagram is illustrated in accordance with the present disclosure. The diagram may begin at 800 and progress to 802 where the apparatus may detect an operating condition. The operating condition may include those previously described. Based on detecting an operating condition, the apparatus may delay the unattended wakeup event for a predetermined amount of time at 804. The flow diagram may then end at 806.

In various embodiments, delaying an amount of time may include setting a timer up expiration of which, the apparatus may again attempt an unattended wakeup event. The amount of time, in one example, may be an hour, although other amounts of time are contemplated.

Referring now to FIG. 9, another flow diagram is illustrated in accordance with the present disclosure. The method may begin at 900 and progress to 902 where the apparatus may detect an operating condition as previously described. Based upon detecting an operating condition, the apparatus may delay an unattended wakeup event at 904.

Continuing to 906, the apparatus may monitor the detected operating condition to determine whether any changes have occurred or whether the operating condition has ceased. For example, if the operating condition is a high or low temperature, the apparatus may monitor the temperature to determine whether it has returned to an operable temperature. If the operating condition is still present at 9G6, the apparatus may again delay the unattended wakeup at 904. If the operating condition has changed, expired, or ceases, the apparatus may transition from the first power state to the second power state to perform an operation in accordance with the unattended wakeup event at 910. The flow diagram may then end at 910.

Referring to FIG. 10, another flow diagram is illustrated in accordance with the present disclosure. The flow diagram begins at 1000 and continues to 1002 where the apparatus may detect an operating condition as previously described. Upon detection of an operating condition, the apparatus may delay an unattended wakeup event at 1004.

The delay may persist until favorable operating conditions are detected at 1006. Detecting favorable operating conditions may include a determination that the apparatus is stable and not moving, operating within an environment having a temperature within an operational range, that the apparatus has an operating temperature within a predetermined range, or that the apparatus is within an available and accessible network. Other favorable operating conditions are contemplated.

Upon detecting a favorable operating condition at 1006, the apparatus may perform an unattended wakeup event at 1008. The unattended wakeup event may include transitioning the apparatus from a first power state to a second power state to perform an operation. The method may then end at 1010.

Referring now to FIG. 11 another flow diagram is illustrated in accordance with an embodiment. The flow diagram may begin at 1100 and continue to 1102 where the apparatus may detect an available and accessible network. Upon detection of the available network at 1102, the apparatus may generate an unattended wakeup event at 1104.

Upon generating the unattended wakeup event at 1104, the apparatus may monitor other operating conditions. Upon detecting an operating condition at 1106, the apparatus may delay the unattended wakeup event at 1108. Delaying the unattended wakeup event may include delaying the unattended wakeup event for a predetermined amount of time, until the detected operating condition has expired, or until favorable operating conditions have been detected.

Upon expiration of the delay, the apparatus may transition from the first power state to the second power state at 1110 to perform an operation. Upon execution of the unattended \makeup event at 1110, the flow diagram may end at 1112.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein.

Therefore, it is manifestly intended that embodiments be limit only try the claims and the equivalents thereof.

What is claimed is:

1. A method, comprising:
detecting, by a computing device, an operating condition of the computing device in a first power state; and
delaying, by the computing device, an unattended wakeup event based on the operating condition, wherein the unattended wakeup event transitions the computing device from the first power state to a second power state to perform an operation.

2. The method of claim 1, wherein detecting the operating condition comprises detecting movement of the computing device.

3. The method of claim 1, wherein detecting the operating condition comprises detecting a temperature of the computing device.

4. The method of claim 1, wherein detecting the operating condition comprises detecting availability of a network.

5. The method of claim 1 further comprising:
transitioning the computing device from the first power state to the second power state, wherein a plurality of applications are operational in the second power state.

6. The method of claim 1, wherein delaying the unattended wakeup event comprises delaying the unattended wakeup event for a predetermined amount of time.

7. The method of claim 1, further comprising:
monitoring the detected operating condition; and
wherein delaying the unattended wakeup event comprises delaying the unattended wakeup event based on the monitoring.

8. The method of claim 1, further comprising:
detecting, by the computing device, a favorable operating condition for the computing device; and
performing, by the computing device, the unattended wakeup event based on the favorable operating condition.

9. An apparatus, comprising:
a plurality of sensors;
a processor coupled to the plurality of sensors; and
a memory coupled to the processor, wherein the memory includes a plurality of programming instructions that, if executed by the processor, cause the apparatus to:
generate an unattended wakeup event in response to detection of an available network via a first sensor of the plurality of sensors, wherein the unattended wakeup event is to transition the apparatus from a first power state to a second power state to perform an operation; and
delay the unattended wakeup event in response to an operating condition detected via a second sensor of the plurality of sensors.

10. The apparatus of claim 9, wherein the first sensor of the plurality of sensors is a network sensor to detect availability of a network.

11. The apparatus of claim 9, wherein the second sensor of the plurality of sensors is an accelerometer to detect movement of the apparatus.

12. The apparatus of claim 9, wherein the second sensor of the plurality of sensors is a temperature sensor to detect a temperature of the apparatus.

13. The apparatus of claim 9, wherein the delay comprises a predetermined amount of time.

14. The apparatus of claim 9, wherein the programming instructions, if executed by the processor, further enable the apparatus to:
transition the apparatus from the first power state to the second power state to perform the operation, wherein the transition is in response to expiration of the delay.

15. The apparatus of claim 9, wherein the operation is a query to email server.
